(19) United States
(12) Patent Application Publication
(10) Pub. No.: US 2022/0201972 A1
(43) Pub. Date: Jun. 30, 2022

(54) OUTDOOR PET ENCLOSURE

(71) Applicant: CITY LOO LLC, Kirkland, WA (US)

(72) Inventors: Anastasia Miles, Kirkland, WA (US); Berett Laabs, Kirkland, WA (US)

(21) Appl. No.: 17/336,182

(22) Filed: Jun. 1, 2021

Related U.S. Application Data
(60) Provisional application No. 63/130,512, filed on Dec. 24, 2020.

(51) Int. Cl. A01K 1/03; A01K 1/01; A01K 1/015

(52) U.S. Cl. CPC A01K 1/033; A01K 1/0152; A01K 1/0157; A01K 1/0107

(57) ABSTRACT

An enclosure for use by a pet animal. The enclosure includes one or more sidewalls at least partially defining a hollow interior, a cover attached to at least one of the sidewall(s), and an opening formed in at least one of the sidewall(s). The opening is sized to allow the pet animal to enter and exit the hollow interior therethrough.

### CROSS REFERENCE TO RELATED APPLICATION

This application claims the benefit of U.S. Provisional Patent Application No. 63/130,512, filed on Dec. 24, 2020, which is incorporated herein by reference in its entirety.

### BACKGROUND OF THE INVENTION

### Field of the Invention

The present invention is directed generally toward pet enclosures for use by animals outdoors and/or indoors.

### Description of the Related Art

Many people live with pets, such as dogs and/or cats, and need a place for such animals to relieve themselves. Some people have outdoor spaces where a pet could go to the bathroom but predators (e.g., eagles, coyotes, and the like), and other animals may pose threats for many pets. Additionally, some outdoor spaces are unsafe for many pets, especially when the pet is unsupervised.

### BRIEF DESCRIPTION OF THE SEVERAL VIEWS OF THE DRAWING(S)

Various embodiments in accordance with the present disclosure will be described with reference to the following drawings.

FIG. 1 is a perspective view of a right side of an enclosure to be used as a bathroom area by a pet (e.g., a dog, a cat, and the like) outside (e.g., on a deck) and/or indoors.

FIG. 2 is a perspective view of the right side of the enclosure of FIG. 1 positioned outside and adjacent to a pet door and illustrated with its cover in a closed position.

FIG. 3 is a perspective view of a left side of the enclosure of FIG. 1 positioned outside and adjacent to the pet door and illustrated with its cover in an open position.

FIG. 4 is a perspective view of the right side of the enclosure of FIG. 1 illustrated with a tray positioned inside the enclosure and with material(s) (e.g., artificial grass, real grass, and/or potty pads) positioned inside the tray.

FIG. 5 is a perspective view of the right side of the enclosure of FIG. 1 illustrated with transparent sidewalls and omitting a panel that covers a selected one of the openings formed in left and right sidewalls.

FIG. 6 is a perspective view of a kit for constructing the enclosure of FIG. 1.

FIG. 7 is a top view of the enclosure of FIG. 1.

FIG. 8 is a left side view of the enclosure of FIG. 1.

FIG. 9 is a front view of the enclosure of FIG. 1.

FIG. 10 is a side view of the panel of the enclosure of FIG. 1.

FIG. 11 is a perspective view of a left side of an alternate embodiment of the enclosure of FIG. 1 that includes a handle affixed to the cover.

Like reference numerals have been used in the figures to identify like components.

### DETAILED DESCRIPTION OF THE INVENTION

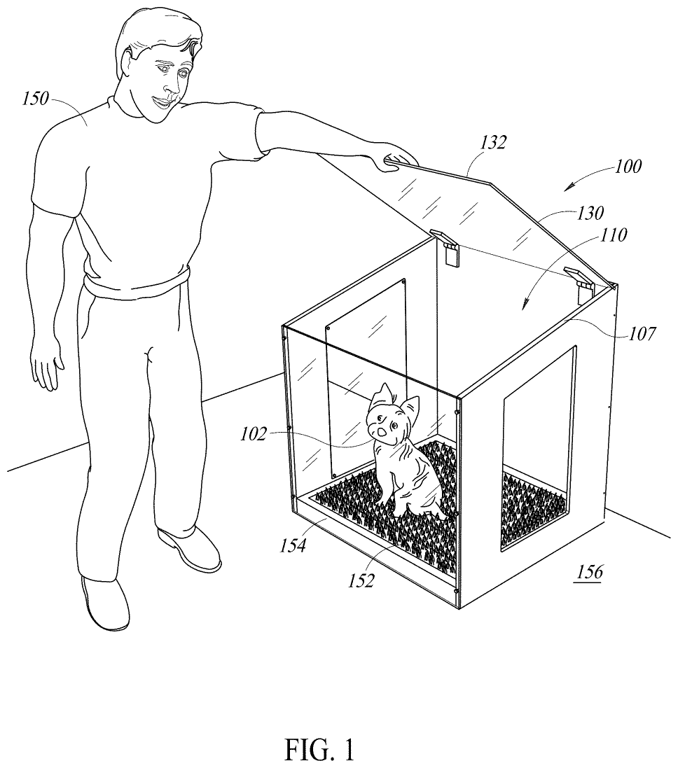

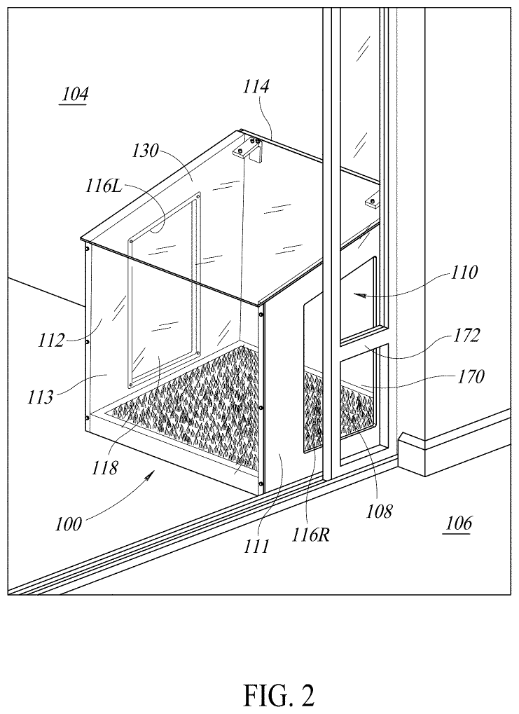

FIG. 1 is a perspective view of an enclosure 100 configured to be used as a bathroom area by a pet 102 (e.g., dog or cat) outside (e.g., on a deck) and/or indoors. In other words, the enclosure 100 may be characterized as being an outhouse or latrine for the pet 102. For example, referring to FIG. 2, the enclosure 100 allows a house pet (e.g., the pet 102 illustrated in FIG. 1) to go to the bathroom in an outside environment 104 and return to the comfort of an interior space 106, such as the pet's home, on its own (e.g., through a conventional pet door 108). In other words, referring to FIG. 1, the pet 102 need not be supervised while using the enclosure 100. Further, the enclosure 100 shelters the pet 102 from the outside environment 104 (e.g., predators, precipitation, and the like). The enclosure 100 may be used indoors to keep the pet's ‘potty area’ enclosed, sanitary, and attractive.

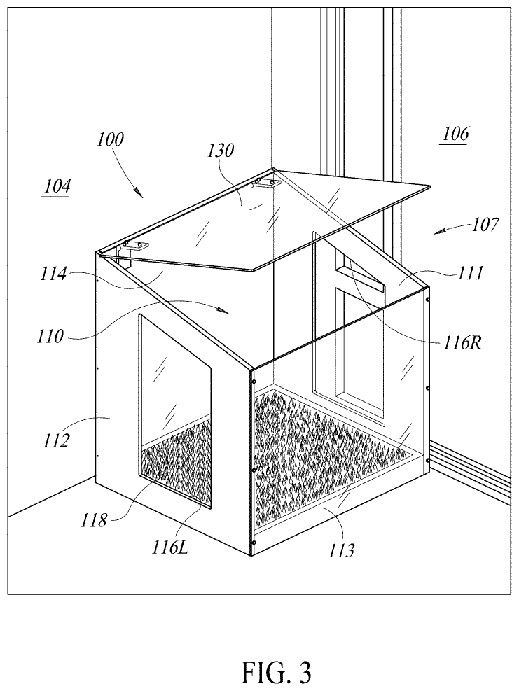

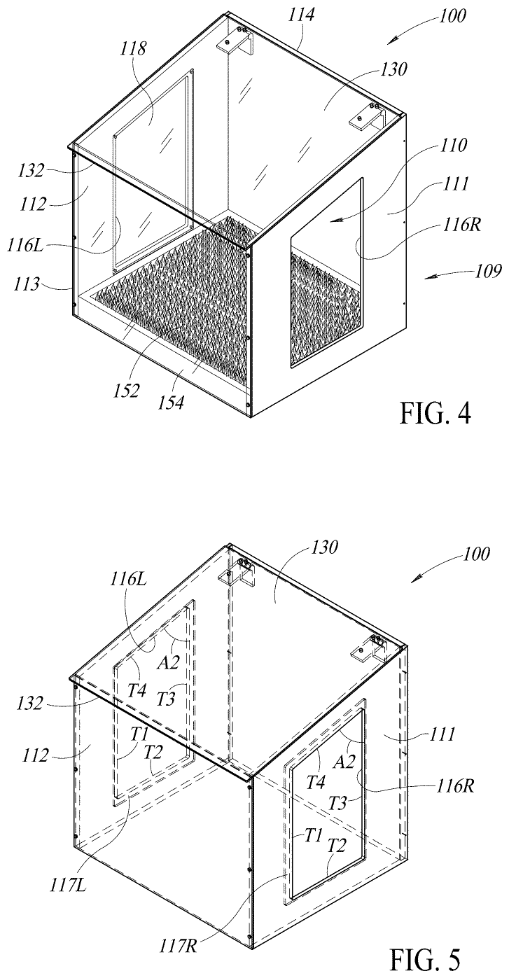

Referring to FIG. 4, the enclosure 100 has one or more upright panels or sidewalls 109 at least partially defining a hollow interior 110 and an opening 107 (see FIGS. 1 and 3) into the hollow interior 110. The sidewall(s) 109 illustrated each have a generally planar shape, however, this is not a requirement. In the embodiment illustrated in FIG. 4, the enclosure 100 has a generally rectangular shaped footprint defined by four upwardly extending sidewalls 111-114. The sidewall 111 is opposite the sidewall 112 and may be characterized as being a right sidewall with the sidewall 112 being characterized as being a left sidewall. The right and left sidewalls 111 and 112 may be substantially identical to one another. However, in alternate embodiments, the right and left sidewalls 111 and 112 may have different shapes. Cutouts or openings 116R and 116L may be formed in the right and left sidewalls 111 and 112, respectively. The openings 116R and 116L may be substantially identical to one another. However, in alternate embodiments, the openings 116R and 116L may have different shapes.

A plate or panel 118 may be positioned over and may close a selected one of the openings 116R and 116L. The panel 118 illustrated has a generally planar shape, however, this is not a requirement. Optionally, referring to FIG. 5, the opening 116L may be surrounded by a groove or dado 117L formed in the left sidewall 112 that is configured to receive and recess the panel 118 (see FIGS. 3, 4, 6, 10, and 11) so that the panel 118 is flush with the inside surface of the left sidewall 112. Similarly, the opening 116R may be surrounded by an optional groove or dado 117R formed in the right sidewall 111 that is configured to receive and recess the panel 118 so that the panel 118 (see FIGS. 3, 4, 6, 10, and 11) is flush with the inside surface of the right sidewall 111.

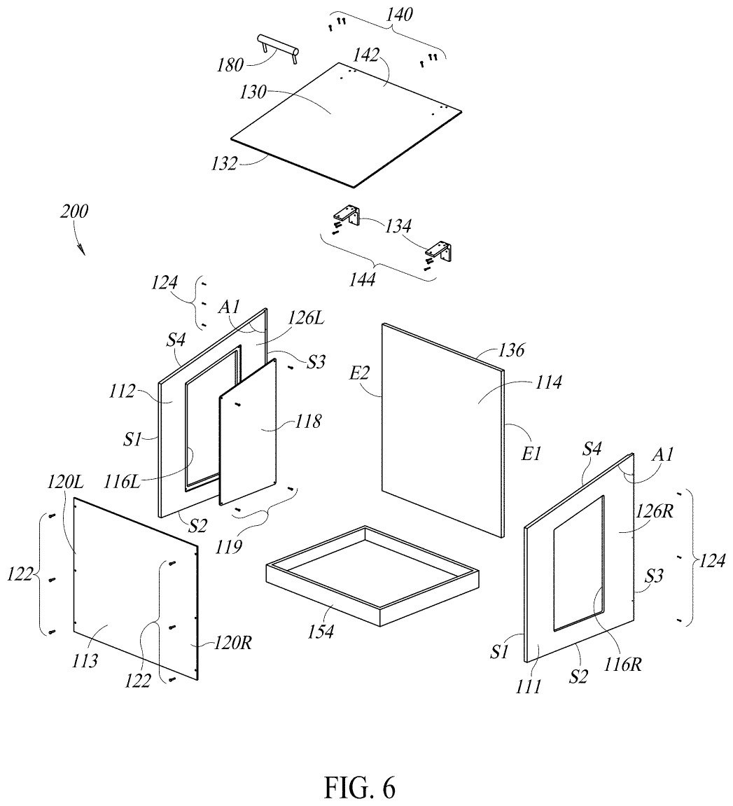

Referring to FIG. 6, each of the right and left sidewalls 111 and 112 may have a generally trapezoidal outer shape defined by four edges S1-S4. The first and third edges S1 and S3 are parallel with one another and each intersect the second edge S2 at a right angle. The third edge S3 is longer than the first edge S1 such that an acute interior angle A1 is defined between the third edge S3 and the fourth edge S4. Thus, the fourth edge S4 slopes downwardly from the third edge S3 toward the first edge S1.

Referring to FIG. 5, the openings 116R and 116L may each have a trapezoidal outer shape defined by four outer edges T1-T4. The first and third edges T1 and T3 are parallel with one another and each intersect the second edge T2 at a right angle. The third edge T3 is longer than the first edge T1 such that an acute interior angle A2 is defined between the third edge T3 and the fourth edge T4. Thus, the fourth edge T4 slopes downwardly from the third edge T3 toward the first edge T1.

Referring to FIG. 6, the panel 118 may be attached to a selected one of the right and left sidewalls 111 and 112 by one or more fasteners 119. In the embodiment illustrated, the panel 118 is positioned to be fastened to the left sidewall 112 (e.g., in the dado 117L illustrated in FIG. 5) by the fastener(s) 119 to cover and close the opening 116L. However, the panel 118 may instead be positioned to be fastened to the right sidewall 111 (e.g., in the dado 117R illustrated in FIG. 5) by the fastener(s) 119 to cover and close the opening 116R.

The sidewall 113 is opposite the sidewall 114 and may be characterized as being a front sidewall with the sidewall 114 being characterized as being a rear sidewall. Referring to FIG. 6, right and left side portions 120R and 120L of the front sidewall 113 are attached (e.g., by fasteners 122) to the front facing first edges S1 of the right and left sidewalls 111 and 112, respectively. Right and left edges E1 and E2 of the rear sidewall 114 are attached (e.g., by fasteners 124) to rear portions 126R and 126L, respectively, of the right and left sidewalls 111 and 112, respectively.

A lid or cover 130 may be attached to one or more of the sidewall(s) 109 (see FIG. 4). The cover 130 illustrated has a generally planar shape, however, this is not a requirement. In the embodiment illustrated, a rear portion 142 of the cover 130 is pivotably attached to a top portion 136 of the rear sidewall 114 by one or more hinges 134. The hinge(s) 134 may be attached to the rear portion 142 of the cover 130 by one or more fasteners 140 (e.g., along an inside surface of the cover 130). The hinge(s) 134 may be attached to the top portion 136 of the rear sidewall 114 by one or more fasteners 144 (e.g., along an inside surface of the rear sidewall 114).

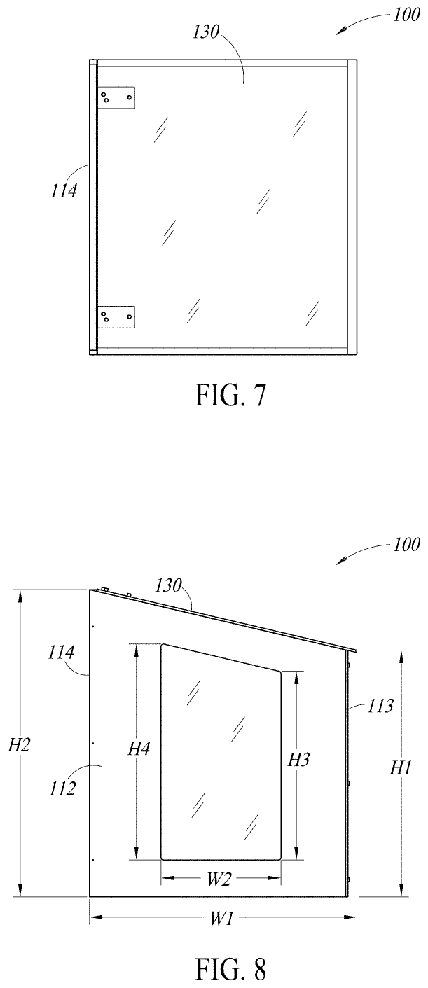

Referring to FIG. 1, a human user 150 may easily pivot the cover 130 upwardly into an open position (see FIGS. 1 and 3), reach into the hollow interior 110 through the opening 107, and replace one or more materials 152 (e.g., artificial grass, real grass, one or more pet potty pads, kitty or cat litter, and the like) used by the pet 102 inside the enclosure 100. Then, the user 150 may pivot the cover 130 downwardly into a closed positioned (see FIGS. 2, 4, 5, 7-9, and 11). When the cover 130 is in the closed position, the enclosure 100 may protect the pet 102 from the weather (e.g., rain and wind) and also help keep the pet 102 safe (e.g., from raptors and/or other predators). Referring to FIG. 4, a front portion of the cover 130 includes a lip portion 132 that extends forwardly beyond the front sidewall 113. Returning to FIG. 1, the user 150 may grip the lip portion 132 to raise and lower the cover 130. Referring to FIG. 6, the cover 130 rests on the sloped fourth edges S4 of the right and left sidewalls 111 and 112, which position the lip portion 132 of the front portion of the cover 130 below the rear portion 142 of the cover 130.

The fasteners 119, 122, 124, 140, and 144 may each be implemented as screws, bolts, nuts, wingnuts, rivets, connectors, latches, a combination thereof, and the like. Further, one or more of the fasteners 119, 122, 124, 140, and 144 may each be replaced with other means for attaching components together, such as adhesive(s), welding, friction based connections, press fit connections, and the like. In some embodiments, referring to FIG. 4, the sidewall(s) 109 may be formed as a single sidewall defining the hollow interior 110. Further, at least one of the sidewall(s) 109 may include one or more bends, curves, and/or corners. While the sidewall(s) 109 have been illustrated as defining a generally rectangular shaped footprint, the sidewall(s) 109 may instead define a differently shaped footprint, such as a footprint having a trapezoidal shape, a triangular shape, a parallelogram shape, a circular shape, an oval shape, a hexagonal shape, an arbitrary shape, a fanciful shape, and the like.

Referring to FIG. 1, optionally, the enclosure 100 may include a removable tray or container 154 for containing the material(s) 152 inside the hollow interior 110 of the enclosure 100. In such embodiments, the user 150 may pivot the cover 130 upwardly into the open position (see FIGS. 1 and 3) and reach into the hollow interior 110 through the opening 107 to clean, remove, and/or replace the container 154 and/or the material(s) 152 (e.g., a grass patch, kitty litter, and the like) positioned inside the container 154. The enclosure 100 may rest on a support surface 156 (e.g., an outside deck) in the outside environment 104 (see FIGS. 2 and 3) and may be open along the support surface 156. In such embodiments, the container 154 may rest directly on the support surface 156. The enclosure 100 may be lifted upwardly to expose the container 154 and may be moved to a location spaced apart and free from the container 154 so that the container 154 and/or the material(s) 152 may be cleaned and/or replaced. The enclosure 100 may help keep the support surface 156 dry and/or sanitary.

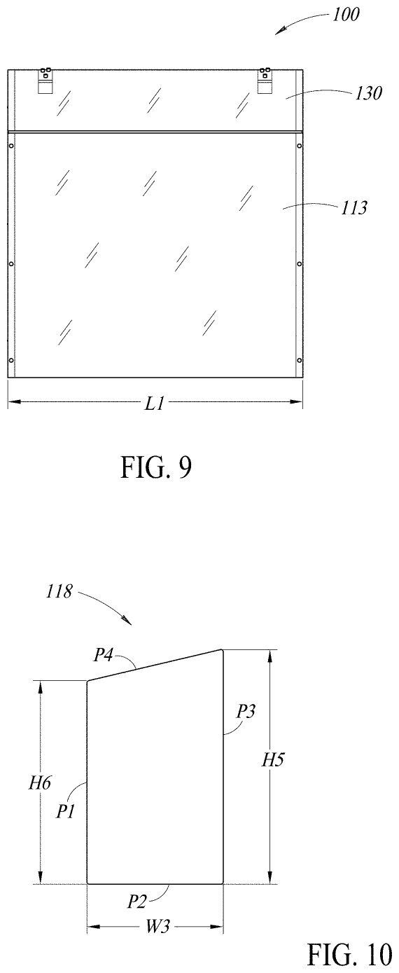

By way of a non-limiting example, the enclosure 100 may be small and lightweight. For example, the enclosure 100 may be sized to accommodate pets of different sizes. By way of a non-limiting example, the enclosure 100 may constructed in three sizes, small, medium, and large. Referring to FIGS. 8 and 9, the enclosure 100 may have a first length L1 ranging from about 20 inches to about 30 inches, a first width W1 ranging from about 14 inches to about 30 inches, a first height H1 along the front sidewall 113 ranging from about 15 inches to about 28 inches, and a second height H2 along the rear sidewall 114 ranging from about 18 inches to about 36 inches. The openings 116R and 116L may each have a second width W2 ranging from about 8 inches to about 16 inches, a third height H3 ranging from about 8 inches to about 22 inches, and a fourth height H4 ranging from about 10 inches to about 26 inches. Referring to FIG. 10, the panel 118 may have a third width W3 ranging from about 8.2 inches to about 18 inches, a fifth height H5 ranging from about 8.2 inches to about 24 inches, and a sixth height H6 ranging from about 10.2 inches to about 28 inches.

Referring to FIG. 4, by way of a non-limiting example, the enclosure 100 may be constructed from durable plastic. One or more of the sidewall(s) 109 may be constructed at least in part from a clear or translucent material (e.g., clear acrylic, Plexiglas, and the like). For example, the front sidewall 113 may be constructed from a clear or translucent material. In such embodiments, the front sidewall 113 may be characterized as being a first window that provides a view of the hollow interior 110 for the user 150 (see FIG. 1) and a view of the outside environment 104 (see FIGS. 2 and 3) for the pet 102 (see FIG. 1). By way of another non-limiting example, the panel 118 may be constructed from a clear or translucent material. In such embodiments, the panel 118 may be characterized as being a second window that provides a view of the hollow interior 110 for the user 150 and a view of the outside environment 104 for the pet 102. By way of yet another non-limiting example, the cover 130 may be constructed from a clear or translucent material. In such embodiments, the cover 130 may be characterized as being a third window that provides a view of the hollow interior 110 for the user 150 and a view of the outside environment 104 for the pet 102.

As mentioned above, the panel 118 is positionable over a selected one of the openings 116R and 116L to cover and close the selected opening, which allows the pet 102 (see FIG. 1) to enter and exit the enclosure 100 through the other uncovered opening. In FIGS. 3 and 4, the panel 118 is illustrated covering the opening 116L. Thus, the pet 102 (see FIG. 1) may enter and exit the enclosure 100 through the uncovered opening 116R, which may provide easy access for the pet 102 into a hollow interior 110 of the enclosure 100. For example, the opening 116R may be cut or carved into the right sidewall 111 and the opening 116L may be cut or carved into the left sidewall 112. Referring to FIG. 2, the opening 116R may be positioned near or adjacent to the conventional pet door 108 to allow the pet 102 to travel from the interior space 106 into the hollow interior 110 of the enclosure 100 through both an opening 170 in the pet door 108 and the opening 116R.

Optionally, an insulating material (not shown) may be positioned in a gap defined between the enclosure 100 and a frame 172, which defines an opening 170 of the pet door 108. The insulating material (not shown) may help prevent heat and/or conditioned air from escaping from the interior space 106 through the gap defined between the enclosure 100 and the frame 172. The gap may be small enough that the pet 102 (see FIG. 1) cannot pass through the gap. Thus, the pet's movement is restricted to the interior space 106 and the hollow interior 110 of the enclosure 100. Optionally, a structure (not shown) that defines a passageway between the opening 170 and the opening 116R may be positioned within the gap to help prevent the pet 102 from escaping through the gap. By way of a non-limiting example, the structure (not shown) may be implemented as an open-ended enclosure having a generally C-shaped cross-sectional shape that defines a tunnel between the opening 170 and the opening 116R that is closed along its top and side portions. By way of another non-limiting example, the structure (not shown) may be implemented as an open-ended tube that defines a tunnel between the opening 170 and the opening 116R. Optionally, the enclosure 100 may anchored in place to prevent the enclosure 100 from sliding outwardly and away from the pet door 108, which would enlarge the gap between the enclosure 100 and the frame 172.

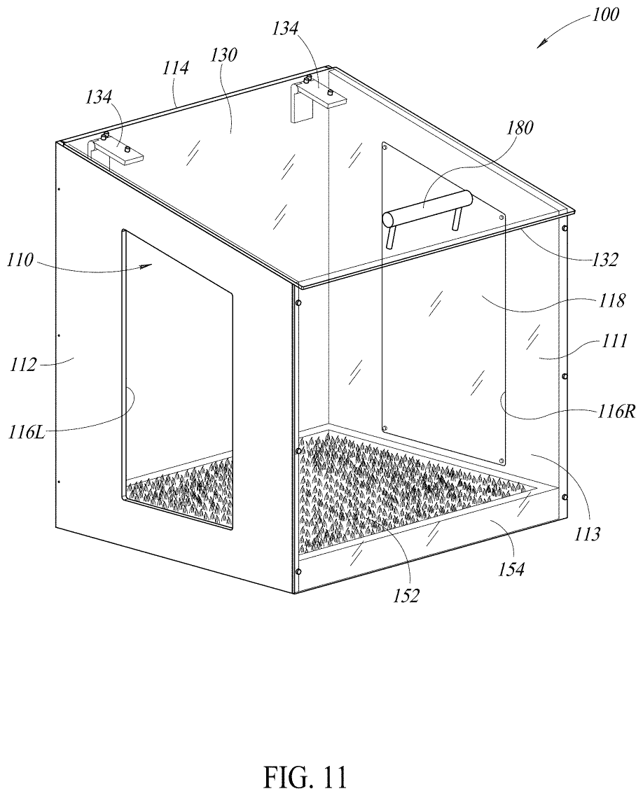

Referring to FIG. 11, optionally, the enclosure 100 may include a handle 180 affixed to a top surface of the cover 130. The handle 180 is configured to be gripped by the user 150 and used to pivot the cover 130. Thus, the user 150 (see FIG. 1) may grip the handle 180 and easily pivot the cover 130 upwardly to the open position (see FIGS. 1 and 3) and downwardly into the closed positioned (see FIGS. 2, 4, 5, 7-9, and 11).

Optionally, the enclosure 100 may include a latch (not shown) or similar mechanism that prevents the pet 102 from opening the cover 130. For example, a first portion (e.g., a hook) of the latch (not shown) may be affixed to the cover 130 and a second mating portion (e.g., an eye) of the latch (not shown) may be affixed to one or more of the sidewall(s) 109 (see FIG. 4). When the latch (not shown) is closed, the latch may help prevent the pet 102 from jumping up, pushing the cover 130 upwardly, and escaping from the enclosure 100 through the opening 107 (see FIGS. 1 and 3). Examples of latches that may be used include a hook and eye latch, a slide bolt, a bailing latch, a shutter bar latch, a catch, a trunk hasp, and the like.

FIG. 11 illustrates the panel 118 attached by the fastener(s) 119 to the right sidewall 111 (e.g., in the dado 117R illustrated in FIG. 5). Thus, the panel 118 covers and closes the opening 116R. In this embodiment, the pet 102 (see FIG. 1) may enter and exit the hollow interior 110 through the opening 116L.

FIG. 9 illustrates a kit 200 for constructing the enclosure 100 (see FIGS. 1-5, 7-9, and 11). The kit 200 may be offered for sale in one or more packages (not shown). The kit 200 includes the sidewalls 111-114, the cover 130, and the panel 118. Optionally, the kit 200 may include the hinge(s) 134, the container 154, the material(s) 152 (see FIGS. 1-4 and 11), the fastener(s) 119, the fasteners 122, the fasteners 124, the fastener(s) 140, the fastener(s) 144, the handle 180, and/or the latch (not shown).

At least one embodiment of the disclosure can be described in view of the following clauses.

1. An enclosure for use by a pet animal, the enclosure comprising: (a) one or more upright sidewalls at least partially defining a hollow interior and a first opening into the hollow interior; (b) a cover pivotally attached to at least one of the one or more upright sidewalls, the cover pivoting with respect to the one or more upright sidewalls between open and closed positions, the cover providing access to the hollow interior through the first opening when the cover is in the open position, the cover closing the first opening into the hollow interior when the cover is in the closed position; and (c) a second opening formed in at least one of the one or more upright sidewalls, the second opening being sized to allow the pet animal to enter and exit the hollow interior therethrough.

2. The enclosure of clause 1, wherein the one or more upright sidewalls comprise a first sidewall opposite a second sidewall, the second opening is formed in the first sidewall, and the enclosure comprises: a third opening formed in the second sidewall; and a panel covering the third opening, the third opening being sized to allow the pet animal to enter and exit the hollow interior therethrough.

3. The enclosure of clause 2, wherein the third opening is identical to the second opening.

4. The enclosure of clause 2 or 3, wherein the one or more upright sidewalls comprise a front sidewall opposite a rear sidewall, the front and rear sidewalls both being attached to the first and second sidewalls.

5. The enclosure of clause 4, wherein the cover and the front sidewall are each constructed from a clear or translucent material.

6. The enclosure of any one of the clauses 2-5, wherein the panel is constructed from a clear or translucent material.

7. The enclosure of any one of the clauses 1-6, further comprising: a container sized to be positioned side the hollow interior and contain at least one material for use by the pet animal.

8. The enclosure of clause 7, wherein the at least one material comprises artificial grass, real grass, one or more potty pads, or cat litter.

9. The enclosure of any one of the clauses 1-8, wherein the cover comprises a handle.

10. The enclosure of clause 1, wherein the one or more upright sidewalls define a rectangular-shaped footprint, the one or more upright sidewalls comprise a first sidewall, a second sidewall, a front sidewall, and a rear sidewall, the first sidewall is opposite the second sidewall, the second opening is formed in the first sidewall, the front sidewall is opposite the rear sidewall, and the front and rear sidewalls are both attached to the first and second sidewalls.

11. The enclosure of clause 10, wherein the first and second sidewalls each have a trapezoidal shape defined by first, second, third, and fourth edges, the first and third edges are parallel with one another and intersect the second edge at a right angle, the third edge is longer than the first edge such that an acute interior angle is defined between the third edge and the fourth edge, and the cover rests on the fourth edge positioning a front portion of the cover below a rear portion of the cover.

12. The enclosure of clause 11, further comprising: a third opening having a trapezoidal shape formed in the second sidewall; and a panel having a trapezoidal shape covering the third opening.

13. A kit for constructing an enclosure for use by a pet animal, the kit comprising: (a) a plurality of sidewalls comprising a right sidewall, a left sidewall, a front sidewall, and a rear sidewall, the right sidewall comprising a right opening sized to allow the pet animal to pass therethrough, the left sidewall comprising a left opening sized to allow the pet animal to pass therethrough, the front and rear sidewalls being couplable to the right and left sidewalls to define a hollow interior therebetween; (b) a panel couplable to a selected one of the right and left sidewalls, the panel covering the right opening when the panel is coupled to the right sidewall, the panel covering the left opening when the panel is coupled to the left sidewall; and (c) a cover couplable to one or more of the plurality of sidewalls.

14. The kit of clause 13, wherein the left opening is identical to the right opening.

15. The kit of clause 13 or 14, wherein the cover and the front sidewall are each constructed from a clear or translucent material.

16. The kit of any one of the clauses 13-15, wherein the panel is constructed from a clear or translucent material.

17. The kit of any one of the clauses 13-16, further comprising: a container sized to be positioned side the hollow interior.

18. The kit of clause 17, further comprising: at least one material for use by the pet animal to be positioned side the container.

19. The kit of clause 18, wherein the at least one material comprises artificial grass, real grass, one or more pet potty pads, or cat litter.

20. The kit of any one of the clauses 13-19, wherein the cover is pivotally couplable to an upper portion of the rear sidewall, an upper opening into the hollow interior is defined by the right sidewall, the left sidewall, the front sidewall, and the rear sidewall; the cover pivots with respect to the rear sidewall between open and closed positions when the cover is pivotally coupled to the upper portion of the rear sidewall, the cover provides access to the hollow interior through the upper opening when the cover is in the open position, and the cover closes the upper opening when the cover is in the closed position.

21. The kit of clause 20, further comprising: a handle mountable on the cover.

22. The kit of any one of the clauses 13-21, wherein the left and right sidewalls each have a trapezoidal shape defined by first, second, third, and fourth edges, the first and third edges are parallel with one another and each intersect the second edge at a right angle, the third edge is longer than the first edge such that an acute interior angle is defined between the third edge and the fourth edge, and the cover rests on the fourth edge of each of the left and right sidewalls to position a front portion of the cover below a rear portion of the cover when the cover is coupled to the one or more of the plurality of sidewalls.

23. The kit of clause 22, wherein the left and right openings each have a trapezoidal shape, and the panel has a trapezoidal shape.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

As used herein, a term joining items in a series (e.g., the term “or,” the term “and,” or the like) does not apply to the entire series of items, unless specifically stated otherwise or otherwise clearly contradicted by context. For example, the phrase “a plurality of A, B, and C” (with or without the Oxford comma) refers to a subset including at least two of the recited items in the series. Thus, the phrase refers to (1) at least one A and at least one B but not C, (2) at least one A and at least one C but not B, (3) at least one B and at least one C but not A, and (4) at least one A and at least one B and at least one C. Similarly, the phrase “a plurality of A, B, or C” (with or without the Oxford comma) refers to a subset including at least two of the recited items in the series. Thus, this phrase also refers to (1) at least one A and at least one B but not C, (2) at least one A and at least one C but not B, (3) at least one B and at least one C but not A, and (4) at least one A and at least one B and at least one C.

By away of another example, conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood with the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B, and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context.

Accordingly, the invention is not limited except as by the appended claims.

The invention claimed is:

1. An enclosure for use by a pet animal, the enclosure comprising:
one or more upright sidewalls at least partially defining a hollow interior and a first opening into the hollow interior;
a cover pivotally attached to at least one of the one or more upright sidewalls, the cover pivoting with respect to the one or more upright sidewalls between open and closed positions, the cover providing access to the hollow interior through the first opening when the cover is in the open position, the cover closing the first opening into the hollow interior when the cover is in the closed position; and
a second opening formed in at least one of the one or more upright sidewalls, the second opening being sized to allow the pet animal to enter and exit the hollow interior therethrough.

2. The enclosure of claim 1, wherein the one or more upright sidewalls comprise a first sidewall opposite a second sidewall, the second opening is formed in the first sidewall, and the enclosure comprises:
a third opening formed in the second sidewall, the third opening being sized to allow the pet animal to enter and exit the hollow interior therethrough; and
a panel covering the third opening.

3. The enclosure of claim 2, wherein the third opening is identical to the second opening.

4. The enclosure of claim 2, wherein the one or more upright sidewalls comprise a front sidewall opposite a rear sidewall, the front and rear sidewalls both being attached to the first and second sidewalls.

5. The enclosure of claim 4, wherein the cover and the front sidewall are each constructed from a clear or translucent material.

6. The enclosure of claim 5, wherein the panel is constructed from a clear or translucent material.

7. The enclosure of claim 1, further comprising:
a container sized to be positioned side the hollow interior and contain at least one material for use by the pet animal.

8. The enclosure of claim 7, wherein the at least one material comprises artificial grass, real grass, one or more potty pads, or cat litter.

9. The enclosure of claim 1, wherein the cover comprises a handle.

10. The enclosure of claim 1, wherein the one or more upright sidewalls define a rectangular-shaped footprint,
the one or more upright sidewalls comprise a first sidewall, a second sidewall, a front sidewall, and a rear sidewall,
the first sidewall is opposite the second sidewall,
the second opening is formed in the first sidewall,
the front sidewall is opposite the rear sidewall, and
the front and rear sidewalls are both attached to the first and second sidewalls.

11. The enclosure of claim 10, wherein the first and second sidewalls each have a trapezoidal shape defined by first, second, third, and fourth edges,
the first and third edges are parallel with one another and intersect the second edge at a right angle,
the third edge is longer than the first edge such that an acute interior angle is defined between the third edge and the fourth edge, and
the cover rests on the fourth edge positioning a front portion of the cover below a rear portion of the cover.

12. The enclosure of claim 11, further comprising:
a third opening having a trapezoidal shape formed in the second sidewall; and
a panel having a trapezoidal shape covering the third opening.

13. A kit for constructing an enclosure for use by a pet animal, the kit comprising:
a plurality of sidewalls comprising a right sidewall, a left sidewall, a front sidewall, and a rear sidewall, the right sidewall comprising a right opening sized to allow the pet animal to pass therethrough, the left sidewall comprising a left opening sized to allow the pet animal to pass therethrough, the front and rear sidewalls being couplable to the right and left sidewalls to define a hollow interior therebetween;
a panel couplable to a selected one of the right and left sidewalls, the panel covering the right opening when the panel is coupled to the right sidewall, the panel covering the left opening when the panel is coupled to the left sidewall; and
a cover couplable to one or more of the plurality of sidewalls.

14. The kit of claim 13, wherein the left opening is identical to the right opening.

15. The kit of claim 13, wherein the cover and the front sidewall are each constructed from a clear or translucent material.

16. The kit of claim 13, wherein the panel is constructed from a clear or translucent material.

17. The kit of claim 13, further comprising:
a container sized to be positioned side the hollow interior.

18. The kit of claim 17, further comprising:
at least one material for use by the pet animal to be positioned side the container.

19. The kit of claim 18, wherein the at least one material comprises artificial grass, real grass, one or more pet potty pads, or cat litter.

20. The kit of claim 13, wherein the cover is pivotally couplable to an upper portion of the rear sidewall,
an upper opening into the hollow interior is defined by the right sidewall, the left sidewall, the front sidewall, and the rear sidewall,
the cover pivots with respect to the rear sidewall between open and closed positions when the cover is pivotally coupled to the upper portion of the rear sidewall,
the cover provides access to the hollow interior through the upper opening when the cover is in the open position, and
the cover closes the upper opening when the cover is in the closed position.

21. The kit of claim 20, further comprising:
a handle mountable on the cover.

22. The kit of claim 13, wherein the left and right sidewalls each have a trapezoidal shape defined by first, second, third, and fourth edges,
the first and third edges are parallel with one another and each intersect the second edge at a right angle,
the third edge is longer than the first edge such that an acute interior angle is defined between the third edge and the fourth edge, and
the cover rests on the fourth edge of each of the left and right sidewalls to position a front portion of the cover below a rear portion of the cover when the cover is coupled to the one or more of the plurality of sidewalls.

23. The kit of claim 22, wherein the left and right openings each have a trapezoidal shape, and
the panel has a trapezoidal shape.
